(19) United States
(12) Patent Application Publication
(10) Pub. No.: US 2024/0386001 A1
(43) Pub. Date: Nov. 21, 2024

(54) Identity Resolution Using Iterative Supervised Machine Learning

(71) Applicant: Redpoint Global, Wellesley, MA (US)

(72) Inventors: Vincent William Porto, Encinitas, CA (US); Jonathan Caplan, Conway, AR (US)

(21) Appl. No.: 18/317,134

(22) Filed: May 15, 2023

(51) Int. Cl. G06F 16/215; G06F 16/28

(52) U.S. Cl. CPC G06F 16/215; G06F 16/285

(57) ABSTRACT

Embodiments included herein are directed towards a method for performing identity resolution using iterative supervised machine learning. Embodiments may include storing a plurality of unresolved records at a database and performing data pre-processing on the plurality of unresolved records. Embodiments may further include creating one or more pairwise links between one or more potential records to be considered for merging and generating a feature similarity score. Embodiments may also include performing initial algorithmic matching to identify one or more matched records and one or more unmatched records and storing the one or more matched records and one or more unmatched records at an unmatched record database and a matched record database. Embodiments may further include performing a supervised record review of the unmatched records and iteratively training a machine learning matching model until all unmatched records are resolved.

### BACKGROUND

Current technologies typically incorporate a single, simplistic scoring function to match records within a group of potential candidates. Unresolved records that do not pass the scoring criteria are referred for manual review and resolution, or worse, declared as individual ‘unique’ entities which are not fully resolved. Use of any such unresolved records results in business inefficiencies including additional costs (e.g., duplicate messaging).

### SUMMARY

In one or more embodiments of the present disclosure, a computer-implemented method for performing identity resolution using iterative supervised machine learning. Embodiments may include storing a plurality of unresolved records at a database and performing data pre-processing on the plurality of unresolved records. Embodiments may further include creating one or more pairwise links between one or more potential records to be considered for merging and generating a feature similarity score. Embodiments may also include performing initial algorithmic matching to identify one or more matched records and one or more unmatched records and storing the one or more matched records and one or more unmatched records at an unmatched record database and a matched record database. Embodiments may further include performing a supervised record review of the unmatched records and iteratively training a machine learning matching model until all unmatched records are resolved.

One or more of the following features may be included. In some embodiments, the method may include causing a display of at least one resolution recommendation. The method may further include allowing a manual resolution at a graphical user interface. The method may also include updating a machine learning algorithm based upon, the manual resolution. The machine learning algorithm may be one or more of decision tree, random forest, boosting method, probabilistic model, and neural networks. The method may also include performing re-indexing, comparison and re-scoring on the unmatched results from the machine learning matching model. The method may further include providing the results of the re-training to the unmatched records database.

In another embodiment of the present disclosure, a non-transitory computer readable storage medium having stored thereon instructions, which when executed by a processor result in one or more operations is provided. Operations may include storing a plurality of unresolved records at a database and performing data pre-processing on the plurality of unresolved records. Embodiments may further include creating one or more pairwise links between one or more potential records to be considered for merging and generating a feature similarity score. Embodiments may also include performing initial algorithmic matching to identify one or more matched records and one or more unmatched records and storing the one or more matched records and one or more unmatched records at an unmatched record database and a matched record database. Embodiments may further include performing a supervised record review of the unmatched records and iteratively training a machine learning matching model until all unmatched records are resolved.

One or more of the following features may be included. In some embodiments, the method may include causing a display of at least one resolution recommendation. The method may further include allowing a manual resolution at a graphical user interface. The method may also include updating a machine learning algorithm based upon, the manual resolution. The machine learning algorithm may be one or more of decision tree, random forest, boosting method, probabilistic model, and neural networks. The method may also include performing re-indexing, comparison and re-scoring on the unmatched results from the machine learning matching model. The method may further include providing the results of the re-training to the unmatched records database.

In one or more embodiments of the present disclosure, a system for performing identity resolution using iterative supervised machine learning is provided. The system may include a database configured to store a plurality of unresolved records. The system may include at least one processor configured to perform data pre-processing on the plurality of unresolved records and to create one or more pairwise links between one or more potential records to be considered for merging. The at least one processor may be further configured to generate a feature similarity score and perform initial algorithmic matching to identify one or more matched records and one or more unmatched records. The at least one processor may be further configured to cause storing of the one or more matched records and one or more unmatched records at an unmatched record database and a matched record database. The at least one processor may be further configured to perform a supervised record review of the unmatched records and to iteratively train a machine learning matching model until all unmatched records are resolved.

One or more of the following features may be included. In some embodiments, the at least one processor may be further configured to cause a display of at least one resolution recommendation. The at least one processor may be further configured to allow a manual resolution at a graphical user interface. The at least one processor may be further configured to update a machine learning algorithm based upon, the manual resolution. The machine learning algorithm may be one or more of decision tree, random forest, boosting method, probabilistic model, and neural networks. The at least one processor may be further configured to perform re-indexing, comparison and re-scoring on the unmatched results from the machine learning matching model.

Additional features and advantages of embodiments of the present disclosure will be set forth in the description which follows, and in part will be apparent from the description, or may be learned by practice of embodiments of the present disclosure. The objectives and other advantages of the embodiments of the present disclosure may be realized and attained by the structure particularly pointed out in the written description and claims hereof as well as the appended drawings.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the present disclosure and are incorporated in and constitute a part of this specification, illustrate embodiments of the present disclosure and together with the description serve to explain the principles of embodiments of the present disclosure.

FIG. 1 diagrammatically depicts an identity resolution process coupled to a distributed computing network;

FIG. 2 depicts a flowchart showing an example identity resolution process consistent with embodiments of the present disclosure;

FIG. 3 depicts a diagram consistent with embodiments of the present disclosure;

FIG. 4 depicts an example graphical user interface consistent with embodiments of the present disclosure; and

FIG. 5 depicts an example graphical user interface consistent with embodiments of the present disclosure.

### DETAILED DESCRIPTION

As discussed above, current technologies typically incorporate a single, simplistic scoring function to match records within a group of potential candidates. Unresolved records that do not pass the scoring criteria are referred for manual review and resolution, or worse, declared as individual ‘unique’ entities which are not fully resolved. Use of any such unresolved records results in business inefficiencies including additional costs (e.g., duplicate messaging). Embodiments of the identity resolution process described herein facilitate the reduction of any remaining unmatched records down to a completely resolved set, increasing the efficiency and effectiveness of any business system using the records.

Reference will now be made in detail to the embodiments of the present disclosure, examples of which are illustrated in the accompanying drawings. The present disclosure may, however, be embodied in many different forms and should not be construed as being limited to the embodiments set forth herein; rather, these embodiments are provided so that this disclosure will be thorough and complete, and will fully convey the concept of the present disclosure to those skilled in the art. Like reference numerals in the drawings denote like elements.

### System Overview

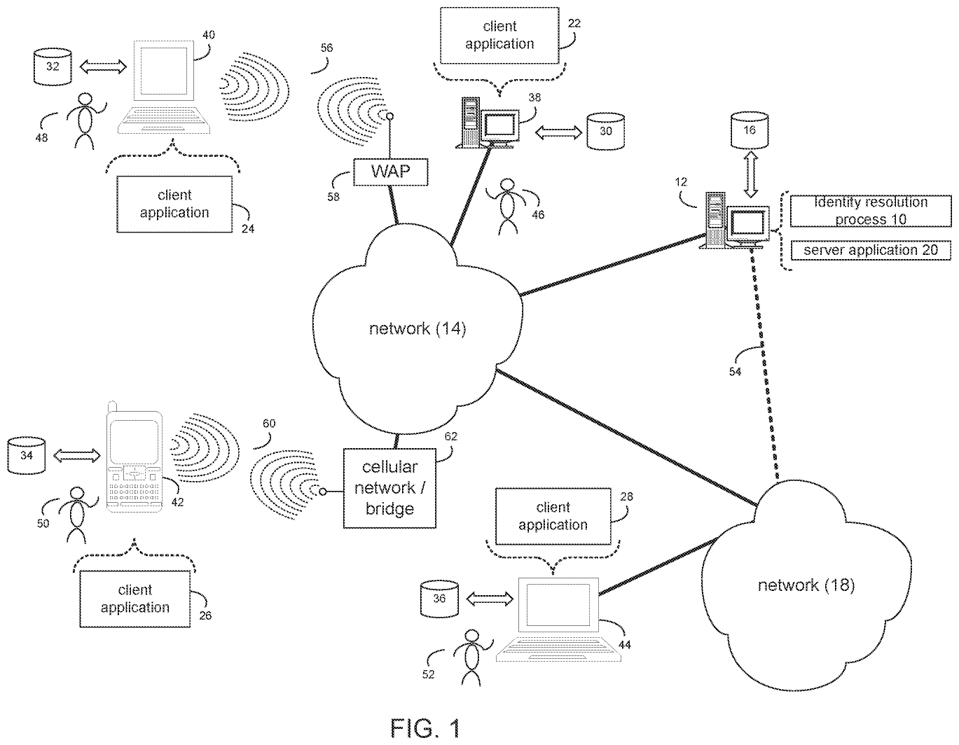

Referring to FIG. 1, there is shown an identity resolution process 10 that may reside on and may be executed by server computer 12, which may be connected to network 14 (e.g., the internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example. Additionally and/or alternatively, identity resolution process 10 may reside on a client electronic device, such as a personal computer, notebook computer, personal digital assistant, or the like.

The instruction sets and subroutines of identity resolution process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute one or more server applications (e.g., server application 20), examples of which may include but are not limited to, e.g., Microsoft Exchange™ Server. Server application 20 may interact with one or more client applications (e.g., client applications 22, 24, 26, 28) in order to execute identity resolution process 10. Examples of client applications 22, 24, 26, 28 may include, but are not limited to, design verification tools such as those available from the assignee of the present disclosure. These applications may also be executed by server computer 12. In some embodiments, identity resolution process 10 may be a stand-alone application that interfaces with server application 20 or may be applets/applications that may be executed within server application 20.

The instruction sets and subroutines of server application 20, which may be stored on storage device 16 coupled to server computer 12, may be executed by one or more processors (not shown) and one or more memory architectures (not shown) incorporated into server computer 12.

As mentioned above, in addition/as an alternative to being server-based applications residing on server computer 12, identity resolution process 10 may be a client-side application residing on one or more client electronic devices 38, 40, 42, 44 (e.g., stored on storage devices 30, 32, 34, 36, respectively). As such, identity resolution process 10 may be a stand-alone application that interface with a client application (e.g., client applications 22, 24, 26, 28), or may be applets/applications that may be executed within a client application. As such, identity resolution process 10 may be a client-side process, server-side process, or hybrid client-side/server-side process, which may be executed, in whole or in part, by server computer 12, or one or more of client electronic devices 38, 40, 42, 44.

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and memory stick storage devices. Examples of client electronic devices 38, 40, 42, 44 may include, but are not limited to, personal computer 38, laptop computer 40, personal digital assistant 42, notebook computer 44, a data-enabled, cellular telephone (not shown), and a dedicated network device (not shown), for example.

Users 46, 48, 50, 52 may access server application 20 directly through the device on which the client application (e.g., client applications 22, 24, 26, 28) is executed, namely client electronic devices 38, 40, 42, 44, for example. Users 46, 48, 50, 52 may access server application 20 directly through network 14 or through secondary network 18. Further, server computer 12 (e.g., the computer that executes server application 20) may be connected to network 14 through secondary network 18, as illustrated with phantom link line 54.

In some embodiments, identity resolution process 10 may be a cloud-based process as any or all of the operations described herein may occur, in whole, or in part, in the cloud or as part of a cloud-based system. The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (CSMA/CA) for path sharing. The various 802.11x specifications may use phase-shift keying (PSK) modulation or complementary code keying (CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™, Redhat Linux™, Apple iOS, ANDROID, or a custom operating system.

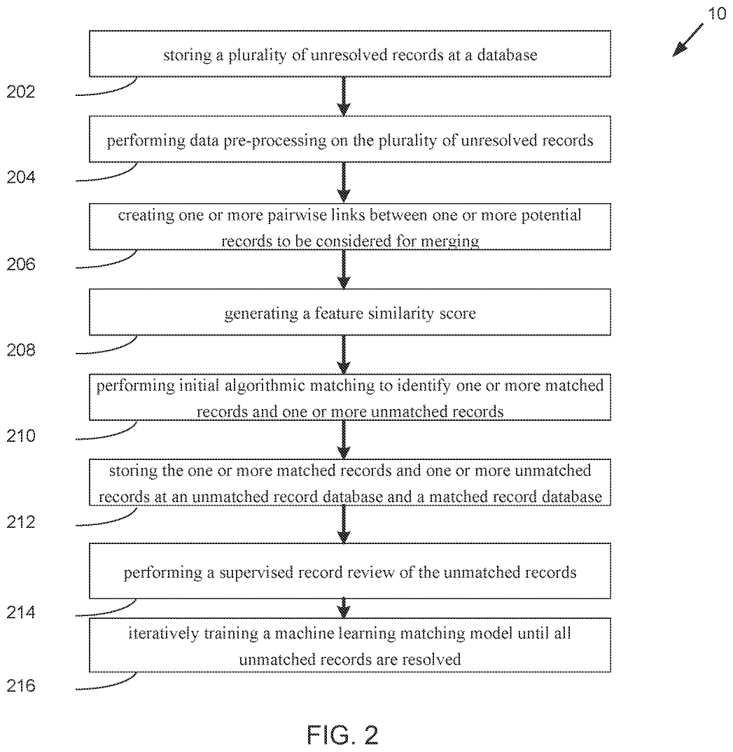

Referring now to FIG. 2, a flowchart showing one or more operations consistent with embodiments of identity resolution process 10 is provided. Embodiments may include storing (202) a plurality of unresolved records at a database and performing (204) data pre-processing on the plurality of unresolved records. Embodiments may further include creating (206) one or more pairwise links between one or more potential records to be considered for merging and generating (208) a feature similarity score. Embodiments may also include performing (210) initial algorithmic matching to identify one or more matched records and one or more unmatched records and storing (212) the one or more matched records and one or more unmatched records at an unmatched record database and a matched record database. Embodiments may further include performing (214) a supervised record review of the unmatched records and iteratively training (216) a machine learning matching model until all unmatched records are resolved. Numerous additional operations are also within the scope of the present disclosure, which are discussed in further detail hereinbelow.

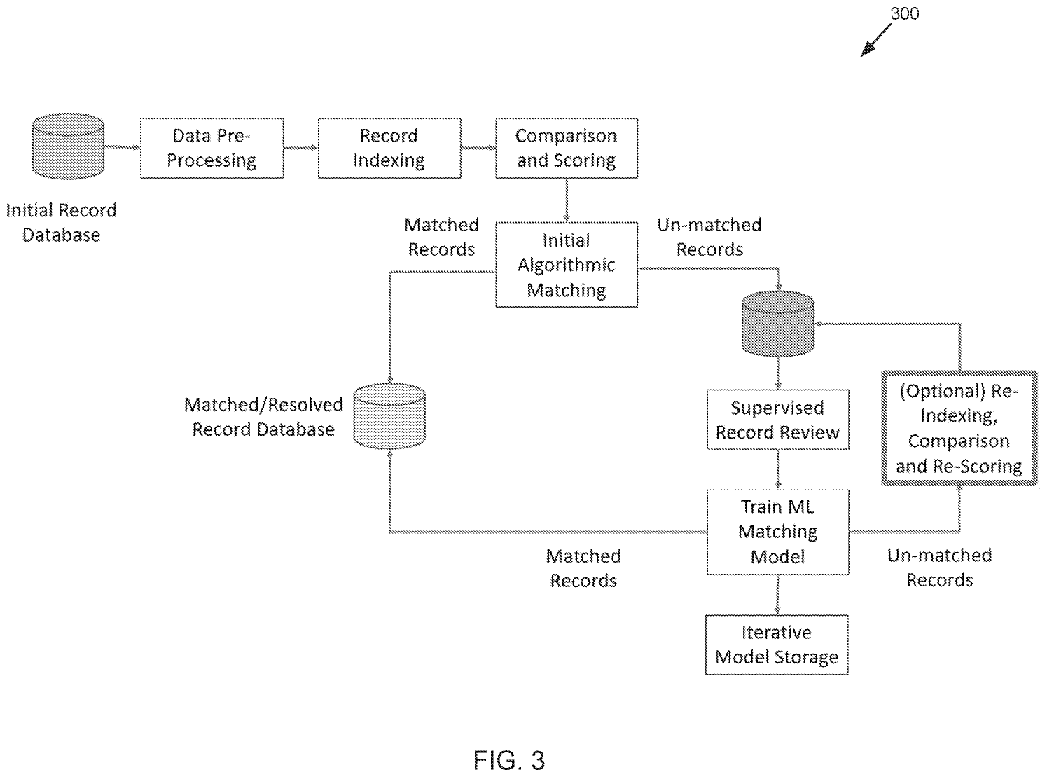

Referring again to FIG. 3, embodiments may include an initial record database and a data pre-processing operation. This may include, for example, name standardization, upper-lower case, punctuation, normalization, stop-word normalization (Mr., Mrs., Dr., Ltd., Rd., Road, St., Street, etc.), symbol removal (+, dash), irrelevant field/symbol removal is performed on a database (DB0). Name standardization processing may include 1) removal of characters that are not in a pre-defined ASCII or Unicode range, 2) conversion of characters to all upper case or all lower case, 3) parsing formal names into (potentially locally geographic) standardized fields (e.g., first, last, suffix), 4) mapping address keywords into (potentially geographically localized) word fields (e.g., Rd. into Road), and 5) removal and/or re-mapping of irrelevant/unwanted symbols or characters contained within the identification information (e.g., replacing the dash character in “Smith-Jones” with a space). The record indexing operation may include the creation of pairwise links between potential records to be considered for merging. Some methodologies may include, but are not limited to, full pairwise indexing (e.g., via the formation of all possible combinations), blocking based on common-value (e.g., column) correlations, sorted neighborhood matching, etc. A combination of these indexing techniques may be used to reduce the potential for missing possible matching records. The comparison and feature similarity score generation operation may include potential measures/metrics such as, but not limited to, distance calculations (e.g., Levenshtein, Jaro-Winkler, Jaccard, LCS, cosine, etc.). In brief, the Levenshtein edit distance measure (See Navarro, G. (2001) “A guided tour to approximate string matching”, ACM Computing Surveys, (33) 1, pp. 31-88) calculates the distance between two words as a function of the minimum number single-character edits (substitution, deletion, and insertion) required to convert one word to the other. In a similar fashion, the Jaro-Winkler measure (See, Winkler, W. E. (1990) “String Comparator Metrics and Enhanced Decision Rules in the Fellegi-Sunter Model of Record Linkage”, Proc. of the Section on Survey Research, pp. 354-359) calculates the distance between two words weighted by a prefix scale that favors string matching from the beginning of the words. Jaccard distance (See, Jaccard, P. (1912) “The distribution of the flora in the alpine zone”, New Phytologist (11) 2, pp. 37-50) measures the ratio of the intersection over the union of two sets of features. Longest common subsequence (LCS) edit distance (See, Bergroth, L., Hakonen, H., and Raita, T. (2000) “A survey of longest common subsequence algorithms”, Proc. 7^{th} International Symposium on String Processing and Information Retrieval (SPIRE), pp. 39-48), is similar to Levenshtein distance, but does not allow substitution. The cosine similarity metric (See, Singal, A. (2001) “Modern Information Retrieval: A Brief Overview”, Bulletin IEEE Computer Society Technical Committee on Data Engineering (24) 4, pp. 35-43) measures the included angle between two (vectorized) text strings/documents irrespective of their relative size.

In some embodiments, identity resolution process 10 may include a classification stage, which may include machine learning via supervised learning. Input features that may be generated at the comparison and feature similarity score generation stage may be combined with one or more truth labels (e.g., binary yes/no match) generated via subject matter expert (SME), known databases, client review, etc.

In some embodiments, the initial classification algorithm used to generate the initial set of matched/unmatched records may not be limited to the use of a machine learning approach and may potentially utilize heuristic or other classification methodologies. The application of the specific machine learning algorithm implemented at each step in the iterative process may depend on the need for explainable post-classification (model) rationale. Decision trees, though potentially brittle classifiers provide full explanatory information regarding the rules generated within the model. If this is not a concern, standard logistic regression (e.g., via least squares or artificial neural networks) or other machine-learning classification algorithm(s) may be used.

In some embodiments, identity resolution process 10 may include a record merging operation. This may include merging data between each pair of records that have been determined to represent the same entity. The set of matched records may be stored in matched records database (DB-M) for subsequent use. The set of unmatched records may be stored in an unmatched records database (DB-UM). The records in the unmatched database may be optionally (re)processed through the indexing and comparison and feature score generation operations discussed above.

In some embodiments, identity resolution process 10 may allow for manual or automated supervised review (e.g., labeling), which may be performed to assess the remaining unmatched records. The classification, record merging, storing, reprocessing, and manual or automated supervised review operations discussed above may be repeated until a) there are no remaining unmatched records, 2) the number of remaining unmatched records is less than or equal to a desired number (i.e., as specified by a client), or 3) the process has reached a specified number of iterations.

In some embodiments, model refinement of the machine learning classification algorithm(s), parameters, configuration(s) may be updated during the learning phase wherein either a) the full, entire set of unmatched records is appropriately re-labeled and re-used, or b) as a reduced set of records containing only the unmatched items from the latest iteration. Model refinement may also consist of modifications to the configuration(s), parameterization(s) and selection of applicable models (e.g., initial model algorithms might be different than algorithms selected for use in later iterations based on prospective performance accuracy, process training times, and/or other designated constraints).

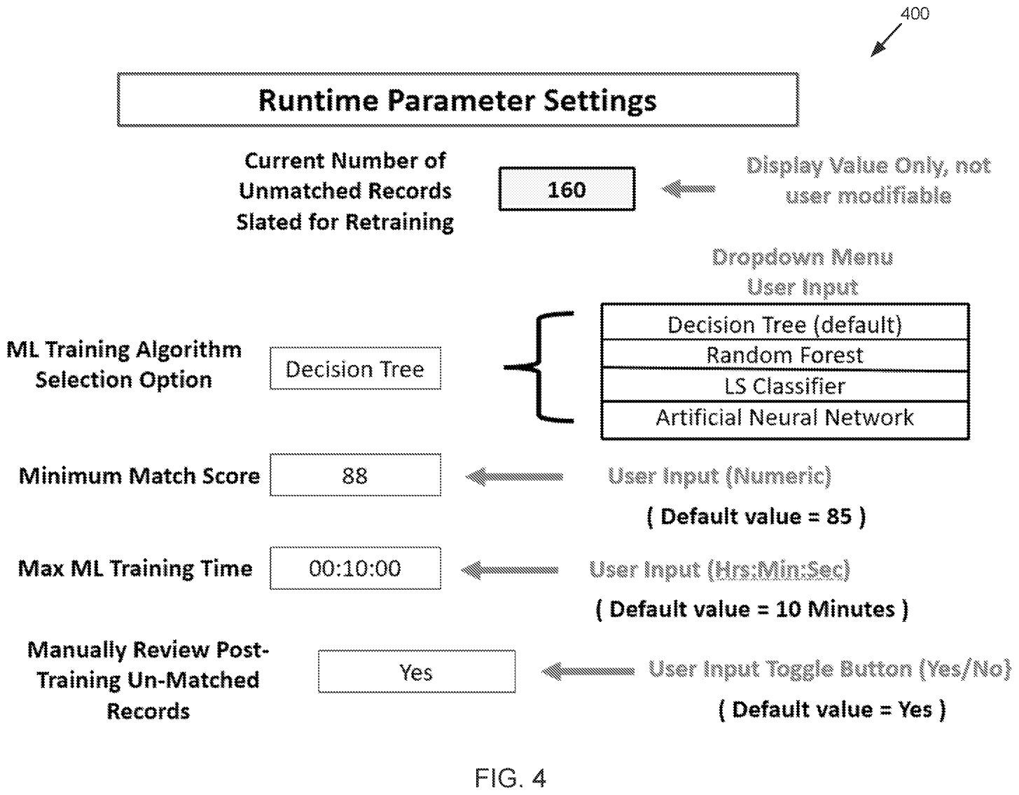

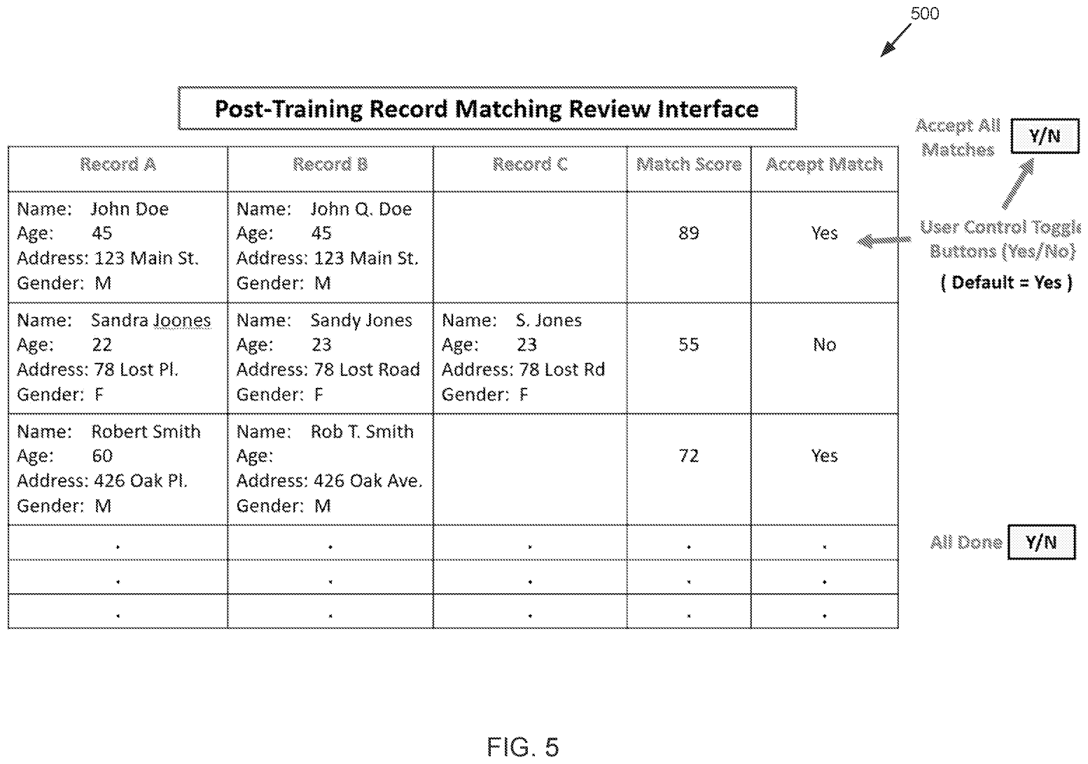

Referring now to FIGS. 4-5, examples of graphical user interfaces consistent with embodiments of identity resolution process 10 are provided. In FIG. 4. At the top the user is shown the number of number of records to process. Thereafter they subsequently select the choice of machine learning (ML) algorithm to use for training and generation of prediction scores for the set of input records. Note that, for all user inputs, default options facilitate rapid operation and potential automation of the operational processes. Next, the user may set (or accept the default) threshold value for accepting predictions (i.e., values meeting or exceeding the scoring threshold). This effectively realizes a filter to accept/reject record matches based on (post-trained) prediction scores. Management of computational time allocated to machine learning algorithm training is also available as an user input parameter. This value provides user control of the maximum time allowed for ML training during each iterative cycle. Finally the user is given the option to automatically accept all predicted record matches, or alternatively perform a manual review (e.g., visual inspection) of match results before acceptance. Shown in FIG. 5. is an example of a manual review user interface wherein predicted data record matches are presented together with their ML match prediction scores, with user-selectable controls for accepting/rejecting each individual match. Default (i.e., “yes, accept match”) values facilitate rapid manual review of predicted results.

Embodiments of identity resolution process 10 may provide increased accuracy using supervised learning by incorporation of iterative identification of edge case decision logic. This allows for complex scoring functions that incorporate additional degrees of freedom outside typical batch based, simplistic Pfa/Pcc (probability of false alarm or mis-classification, probability of correct classification) scoring. Simple batch-based probability scoring often uses simple thresholding functions that treat all errors identically. More complex scoring functions such as individual error component weighting, linear/non-linear combination of scoring functions, and degree of achievement (i.e., Valuated State Space approach: See, Porto. V. W. (1997) “Evolution of Intelligently Interactive Behaviors for Simulated Forces”, Evolutionary Programming VI, 6^{th} International Conference EP97, Springer Verlag, pp. 419-429 and Michalewicz, Z. and Fogel, D., (2004) How to solve it. Modern Heuristics, Springer, 2^{nd} ed., pp. 443-449) functions provide more flexibility and better real-world results when compared to simple threshold criteria.

In some embodiments, the incorporation of iterated post-training human (or automated) analysis provides for a generalized, automated system for identity resolution that may be uniquely tailored for any desired degree of accuracy and business purpose. Accuracy of the generalized logic used for the bulk of the matching process may not be sacrificed or compromised by the sequential, iterated addition of models as they only need to address remaining unresolved edge cases. Additionally, information gleaned from the sequence of iterated models may be reviewed to adaptively assess if/how the original matching algorithm may 1) be adapted for better performance, 2) learn the relative importance of individual features within the scoring function (e.g., automated ‘knob tuning’), and 3) lead to suggestions of additional or alternative measurement features pertinent to improving the scoring process. It will be apparent to those skilled in the art that various modifications and variations can be made to identity resolution process 10 and/or embodiments of the present disclosure without departing from the spirit or scope of the invention. Thus, it is intended that embodiments of the present disclosure cover the modifications and variations of this invention provided they come within the scope of the appended claims and their equivalents.

1. A computer-implemented method, comprising:
storing a plurality of unresolved records at a database;
performing data pre-processing on the plurality of unresolved records;
creating one or more pairwise links between one or more potential records to be considered for merging;
generating a feature similarity score;
performing initial algorithmic matching using an initial model algorithm to identify one or more matched records and one or more unmatched records;
storing the one or more matched records and one or more unmatched records at a matched record database and an unmatched record database, respectively;
performing a supervised record review of the unmatched records;
iteratively training a machine learning matching model using the unmatched records for reprocessing and manual or automated supervised review operations until all the unmatched records are resolved; and
updating the machine learning matching model by modifying a selection of applicable models, wherein the selection of applicable models includes selecting one or more different model algorithms for use in later iterations than the initial model algorithm based on a prospective performance accuracy and process training times.

2. The computer-implemented method of claim 1, further comprising:
causing a display of at least one resolution recommendation.

3. The computer-implemented method of claim 2, further comprising:
allowing a manual resolution at a graphical user interface.

4. The computer-implemented method of claim 3, further comprising:
updating a machine learning algorithm based upon, the manual resolution.

5. The computer-implemented method of claim 4, wherein the machine learning algorithm is one or more of decision tree, random forest, boosting method, probabilistic model, statistical model, and neural networks.

6. The computer-implemented method of claim 1, further comprising:
performing re-indexing, comparison and re-scoring on the unmatched results from the machine learning matching model.

7. The computer-implemented method of claim 6, further comprising:
providing the results of the re-training to the unmatched records database.

8. A non-transitory computer readable storage medium having stored thereon instructions, which when executed by a processor result in one or more operations, the operations comprising:
storing a plurality of unresolved records at a database;
performing data pre-processing on the plurality of unresolved records;
creating one or more pairwise links between one or more potential records to be considered for merging;
generating a feature similarity score;
performing initial algorithmic matching using an initial model algorithm to identify one or more matched records and one or more unmatched records;
storing the one or more matched records and one or more unmatched records at a matched record database and an unmatched record database, respectively;
performing a supervised record review of the unmatched records;
iteratively training a machine learning matching model using the unmatched records for classification, record merging, storing, reprocessing, and manual or automated supervised review operations by performing re-indexing, comparison and re-scoring on the unmatched records from the machine learning matching model until all the unmatched records are resolved; and
updating the machine learning matching model by modifying configurations, a parameterization and a selection of applicable models, wherein the selection of applicable models includes selecting one or more different model algorithms for use in later iterations than the initial model algorithm based on prospective performance accuracy and process training times.

9. The non-transitory computer readable storage medium of claim 8, wherein operations further comprise:
causing a display of at least one resolution recommendation.

10. The non-transitory computer readable storage medium of claim 9, wherein operations further comprise:
allowing a manual resolution at a graphical user interface.

11. The non-transitory computer readable storage medium of claim 10, wherein operations further comprise:
updating a machine learning algorithm based upon, the manual resolution.

12. The non-transitory computer readable storage medium of claim 11, wherein the machine learning algorithm is one or more of decision tree, random forest, boosting method, probabilistic model, statistical model, and neural networks.

13. (canceled)

14. The non-transitory computer readable storage medium of claim 8, wherein operations further comprise:
providing the results of the re-training to the unmatched records database.

15. A system comprising:
a database configured to store a plurality of unresolved records; and
at least one processor configured to perform data pre-processing on the plurality of unresolved records and to create one or more pairwise links between one or more potential records to be considered for merging, wherein the at least one processor is further configured to generate a feature similarity score and perform initial algorithmic matching using an initial model algorithm to identify one or more matched records and one or more unmatched records, wherein the at least one processor is further configured to cause storing of the one or more matched records and one or more unmatched records at a matched record database and an unmatched record database, respectively, wherein the at least one processor is further configured to perform a supervised record review of the unmatched records, wherein the at least one processor is further configured to iteratively train a machine learning matching model using the unmatched records for classification, record merging, storing, reprocessing, and manual or automated supervised review operations by performing re-indexing, comparison and re-scoring on the unmatched records from the machine learning matching model until all the unmatched records are resolved, wherein the at least one processor is further configured to update the machine learning matching model by modifying configurations, a parameterization and a selection of applicable models, wherein the selection of applicable models includes selecting one or more different model algorithms for use in later iterations than the initial model algorithm based on prospective performance accuracy and process training times.

16. The system of claim 15, wherein the at least one processor is further configured to cause a display of at least one resolution recommendation.

17. The system of claim 16, wherein the at least one processor is further configured to allow a manual resolution at a graphical user interface.

18. The system of claim 17, wherein the at least one processor is further configured to update a machine learning algorithm based upon, the manual resolution.

19. The system of claim 18, wherein the machine learning algorithm is one or more of decision tree, random forest, boosting method, probabilistic model, statistical model, and neural networks.

20. (canceled)
